(19) United States
(12) Patent Application Publication
(10) Pub. No.: US 2007/0211202 A1
(43) Pub. Date: Sep. 13, 2007

(54) Liquid crystal display device, method of making the same, and electronic apparatus

(75) Inventors: Taiji Ishii, Fujimi-machi (JP); Masanori Akiyama, Shimosuwa-machi (JP)

Correspondence Address: ADVANTEDGE LAW GROUP, LLC, 3301 NORTH UNIVERSITY AVE., SUITE 200, PROVO, UT, 84604, US

(73) Assignee: Seiko Epson Corporation, Tokyo (JP)

(21) Appl. No.: 11/712,608

(22) Filed: Mar. 1, 2007

(30) Foreign Application Priority Data
Mar. 7, 2006 (JP) 2006-060562

(51) Int. Cl. G02F 1/1339

(52) U.S. Cl. 349/153

(57) ABSTRACT

A liquid crystal display device includes a first substrate, a second substrate opposed to the first substrate, a liquid crystal layer between the first and second substrates, a plurality of seals arranged in a sealing area located around a display area in which an image is displayed through the liquid crystal layer, and two sealing portions each connecting ends of the seals to seal the space. The seals extend along the sealing area on the first substrate. The adjacent seals are disposed with a space therebetween in the direction from the center of the display area to the periphery thereof. The seals join the first substrate to the second substrate.

### BACKGROUND

1. Technical Field

The present invention relates to a liquid crystal display device, such as a liquid crystal display panel used as a light valve of a liquid crystal display projector, a method of making the liquid crystal display device, and an electronic apparatus, such as a liquid crystal display projector, including the liquid crystal display device.

2. Related Art

As an example of this type of liquid crystal display device, a liquid crystal display panel includes a first substrate and a second substrate, which are joined to each other with a seal therebetween such that the first substrate is opposed to the second substrate. The seal surrounds liquid crystal molecules constituting a liquid crystal layer between the two substrates to seal the liquid crystal layer, thus providing a display area where an image is displayed by driving the liquid crystal molecules in the liquid crystal layer. JP-A-5-119325 and JP-A-2005-78003 disclose techniques for making the gap between the two substrates uniform to improve image display quality.

In some cases, foreign matter, such as moisture, may penetrate into the liquid crystal display panel, serving as the liquid crystal display device, from outside, causing display abnormalities. Particularly, when the liquid crystal display device is continuously used in hot and humid conditions, foreign matter, such as moisture, gradually diffuses in the seal though the substrates are strongly joined to each other with the seal therebetween. The foreign matter, such as moisture, which has penetrated the device through the seal, gradually deteriorates the liquid crystal layer and alignment layers. This results in a reduction in display quality of the liquid crystal display device. Disadvantageously, strongly joining the substrates with the seal therebetween is insufficient to completely prevent penetration of moisture. Even if the width of the seal is increased, it is difficult to effectively suppress the diffusion of moisture in the seal.

### SUMMARY

An advantage of some aspects of the invention is to provide a liquid crystal display device capable of preventing a reduction in display quality, a method of making the liquid crystal display device, and an electronic apparatus including the liquid crystal display device.

According to a first aspect of the invention, a liquid crystal display device includes a first substrate, a second substrate opposed to the first substrate, a liquid crystal layer between the first and second substrates, a plurality of seals arranged in a sealing area located around a display area in which an image is displayed through the liquid crystal layer, and two sealing portions. The seals extend along the sealing area on the first substrate. The adjacent seals are disposed with a space therebetween in the direction from the center of the display area to the periphery thereof. The seals join the first substrate to the second substrate. The sealing portions each connect ends of the seals to seal the space.

According to the first aspect of the invention, the first and second substrates sandwich the liquid crystal layer composed of liquid crystal molecules. The first and second substrates are joined to each other through the seals. The display area, which serves as a pixel area including a plurality of pixels, i.e., in which an image is displayed, is arranged inside the seals on a surface of the first substrate, the surface being close to the liquid crystal layer. Specifically, the display area is surrounded by the seal that is the closest to the center of the first substrate.

One of the first and second substrates has driving circuits for driving the liquid crystal molecules in the liquid crystal layer. The first substrate has pixel electrodes and the second substrate has a common electrode opposed to the pixel electrodes. A voltage is applied to the liquid crystal layer composed of the liquid crystal molecules by those electrodes, thus displaying an image in the display area.

The seals extend along the sealing area located around the display area on the first substrate. The adjacent seals are disposed with a space therebetween in the direction from the center of the display area to the periphery thereof. Therefore, the display area is surrounded by the seals and the space separating the seals. More specifically, the display area is surrounded by the seal that is the closest to the center of the first substrate.

The sealing portions are arranged so as to connect the respective ends of the seals after the seals are disposed in the sealing area, thus sealing the space separating the seals.

The seals and the space can reduce the amount of foreign matter, such as moisture, penetrating into the display area from outside as compared with a case where the display area is surrounded by a single seal. More specifically, when two seals are arranged, the space between the two seals functions as a buffer area against moisture, so that the amount of moisture which passes through the outer seal and reaches the inner seal is remarkably reduced. Advantageously, the amount of moisture penetrating the display area through the seals and the space separating the seals can be noticeably reduced.

The space separating the seals is sealed by the sealing portions. More specifically, the space is three-dimensionally enclosed by the seals separated by the space, the sealing portions, the first substrate, and the second substrate and is isolated from the outside. This arrangement, therefore, reduces penetration of moisture from the ends of the seals into the space.

Two or more seals may be arranged in the sealing area. To more effectively prevent the penetration of moisture into the display area, it is preferred that three or more seals be disposed. Increasing the number of seals leads to an increase in the number of spaces, each separating the adjacent seals, disposed in the direction from the center of the display area to the periphery thereof. Thus, the total space functioning as a buffer area against moisture is increased. Therefore, this arrangement can increase the sealing performance against moisture and reduce the width of each seal disposed in the direction from the center of the display area to the periphery thereof as compared with a case where the image display area is surrounded by a single seal. Consequently, the width of the sealing area in which the plurality of seals are arranged can be reduced and a wider area on the surface, having a limited area, of the first substrate can be used as the image display area.

As described above, in the liquid crystal display device in accordance with the first aspect of the invention, a deterioration of the liquid crystal layer caused by the penetration of moisture can be suppressed, thus preventing a reduction in display quality. The highly reliable liquid crystal display device capable of maintaining good display quality for a long term can be provided.

According to a second aspect of the invention, a liquid crystal display device includes a first substrate, a second substrate opposed to the first substrate, a liquid crystal layer between the first and second substrates, and a plurality of seals arranged in a sealing area located around a display area in which an image is displayed through the liquid crystal layer. The seals extend along the sealing area on the first substrate. The adjacent seals are disposed with a space therebetween in the direction from the center of the display area to the periphery thereof. Both ends of each seal are connected such that the seal surrounds the display area. The seals join the first substrate to the second substrate.

In the liquid crystal display device according to the second aspect of the invention, a deterioration of the liquid crystal layer caused by penetration of moisture can be suppressed in a manner similar to the liquid crystal display device according to the first aspect, thus preventing a reduction in display performance.

Both ends of each of the seals are connected, thus sealing the space separating the adjacent seals. More specifically, both the ends of each seal are connected such that the seal has a closed shape in the sealing area.

The space is disposed between the seals, each having a closed shape by connecting both the ends thereof, on the first substrate and the upper and lower ends of the space are closed by the first and second substrates. In other words, the space is sealed by the adjacent seals and the first and second substrates.

In this arrangement, the space functions as a buffer area to reduce the amount of penetrating moisture. Advantageously, the penetration of moisture into the display area from outside can be effectively prevented.

As described above, in the liquid crystal display device according to the second aspect of the invention, the good display quality can be maintained for a long term. The highly reliable liquid crystal display device can be provided.

In the liquid crystal display device according to the first aspect of the invention, the space may be maintained under vacuum or be filled with an inert gas.

When the space is maintained under vacuum, there is no medium for scattering foreign matter, such as moisture, which penetrates from outside through the seals, to the center of the display area. Alternatively, when the space is filled with the inert gas, such as nitrogen gas, the degree of scattering of moisture in the inert gas is lower than in other substances. Accordingly, the amount of moisture penetrating the display area can be reduced.

In the liquid crystal display device according to the first aspect of the invention, each seal may include spacers for maintaining the gap between the two substrates at a predetermined distance.

In this case, since the seals extend in the sealing area, the distance between the first and second substrate, i.e., the gap therebetween can be held uniform by the spacers included in the seals during joining the two substrates. Advantageously, a reduction in display quality caused by joining the first and second substrates at an angle can be prevented.

The liquid crystal display device according to the first aspect of the invention may further include at least one partition wall for dividing the space into a plurality of segments.

In this case, if the hermeticity of any of the segments is degraded, foreign matter, such as moisture, penetrates the display area only through the relevant segment. Accordingly, the total amount of moisture penetrating the display area can be reduced.

According to a third aspect of the invention, there is provided a method of making a liquid crystal display device including a first substrate, a second substrate opposed to the first substrate, a liquid crystal layer between the first and second substrates, a plurality of seals arranged in a sealing area located around a display area in which an image is displayed through the liquid crystal layer, and two sealing portions. The method includes integrally forming the seals and the sealing portions on the first substrate such that the seals extend along the sealing area, the adjacent seals are disposed with a space therebetween in the direction from the center of the display area to the periphery thereof, and the sealing portions each connect ends of the seals to seal the space, and joining the first and second substrates through the seals.

According to the method of the third aspect of the invention, a highly reliable liquid crystal display device capable of preventing a reduction in display quality similar to the liquid crystal display device according to the first aspect of the invention can be made.

In the method according to the third aspect of the invention, the sealing portions may be made of the same material as the seals.

Advantageously, the space between the adjacent seals can be easily sealed.

In the liquid crystal display device made by the method according to the third aspect of the invention, the seals and the sealing portions are integrally formed. This means that the seals and the sealing portions are formed as a single-piece construction using the same material by the same step and the same process. More specifically, an uncured sealing material is deposited in droplets in the sealing area on the first substrate by a dispenser such that the sealing material is patterned as a single continuous line. After the seals and sealing portions, which are uncured, are formed by the single step, the first substrate is joined to the second substrate through the seals and the sealing portions. The seals and the sealing portions are cured to fix the first and second substrates to each other.

According to the method of the third aspect of the invention, therefore, the construction to prevent penetration of foreign matter, such as moisture, can be easily formed.

In the method according to the third aspect of the invention, a liquid crystal stopper for sealing the liquid crystal layer may be arranged between the sealing portions.

Since the liquid crystal layer is sealed by the liquid crystal stopper, liquid crystal can be injected into the gap between the two substrates after the seals are formed and the liquid crystal can be prevented from leaking from an area where the seals are not arranged.

According to a fourth aspect of the invention, there is provided a method of making a liquid crystal display device including a first substrate, a second substrate opposed to the first substrate, a liquid crystal layer between the first and second substrates, and a plurality of seals arranged in a sealing area located around a display area in which an image is displayed through the liquid crystal layer. The method includes forming the seals on the first substrate such that the seals extend along the sealing area, the adjacent seals are disposed with a space therebetween in the direction from the center of the display area to the periphery thereof, both ends of each seal are connected so as to surround the display area, and the space continuously extends so as to surround the display area, applying liquid crystal to the display area in a vacuum or in an atmosphere of an inert gas to form the liquid crystal layer, and joining the first and second substrates in the vacuum or in the atmosphere of the inert gas.

According to the method of the fourth aspect of the invention, a highly reliable liquid crystal display device capable of maintaining good display quality for a long term similar to the liquid crystal display device according to the second aspect of the invention can be provided. The method according to the fourth aspect of the invention can be applied to a method of making a liquid crystal display using the one drop fill (ODF) process that is generally used during manufacture of, for example, a liquid crystal display device. For example, when the step of applying liquid crystal to the display area and the step of joining the first and second substrates are performed in a vacuum or in an atmosphere of an inert gas, the space separating the adjacent seals can be maintained under vacuum or be filled with the inert gas. The space maintained under vacuum or filled with the inert gas can prevent penetration of moisture.

According to a fifth aspect of the invention, an electronic apparatus includes the liquid crystal display device according to the first aspect of the invention.

According to the fifth aspect of the invention, since the electronic apparatus includes the liquid crystal display device according to the first aspect of the invention, a high quality image can be displayed. Consequently, highly reliable various electronic apparatuses, e.g., a projector display apparatus, a mobile phone, an electronic organizer, a word processor, view-finder type and monitor-direct-view type video tape recorders, a workstation, a videophone, a POS terminal, and a touch panel can be realized. In addition, an electrophoretic display apparatus, such as an electronic paper, can be realized as an electronic apparatus according to this aspect of the invention.

The above and other features and advantages of the invention will become more apparent from the following description of the preferred embodiments of the invention.

### BRIEF DESCRIPTION OF THE DRAWINGS

The invention will be described with reference to the accompanying drawings, wherein like numbers reference like elements.

FIG. 1 is a plan view of a liquid crystal display device according to a first embodiment of the invention.

FIG. 2 is a cross-sectional view taken from line H-H′ of FIG. 1.

FIG. 3 is a conceptual diagram explaining a state in which the amount of penetrating foreign matter, such as moisture, is reduced.

FIG. 4 is a partially cross-sectional view of the liquid crystal display device according to the first embodiment.

FIG. 5 is a plan view of a liquid crystal display device according to a modification of the first embodiment.

FIG. 6 is a flowchart of a method of making the liquid crystal display device according to the first embodiment.

FIG. 7 is a perspective view explaining a step of patterning a seal assembly in the method of making the liquid crystal display device according to the first embodiment.

FIG. 8 is a plan view of a liquid crystal display device according to a second embodiment of the invention.

FIG. 9 is a flowchart of a method of making the liquid crystal display device according to the second embodiment.

FIG. 10 is a diagram illustrating a step of applying liquid crystal and a step of joining two substrates in the method of making the liquid crystal display device according to the second embodiment.

FIG. 11 is a plan view of an electronic apparatus including the liquid crystal display device according to any of the first and second embodiments.

### DESCRIPTION OF EXEMPLARY EMBODIMENTS

Preferred embodiments of the invention will now be described with reference to the drawings.

### First Embodiment

### 1-1: Structure of Liquid Crystal Display Device

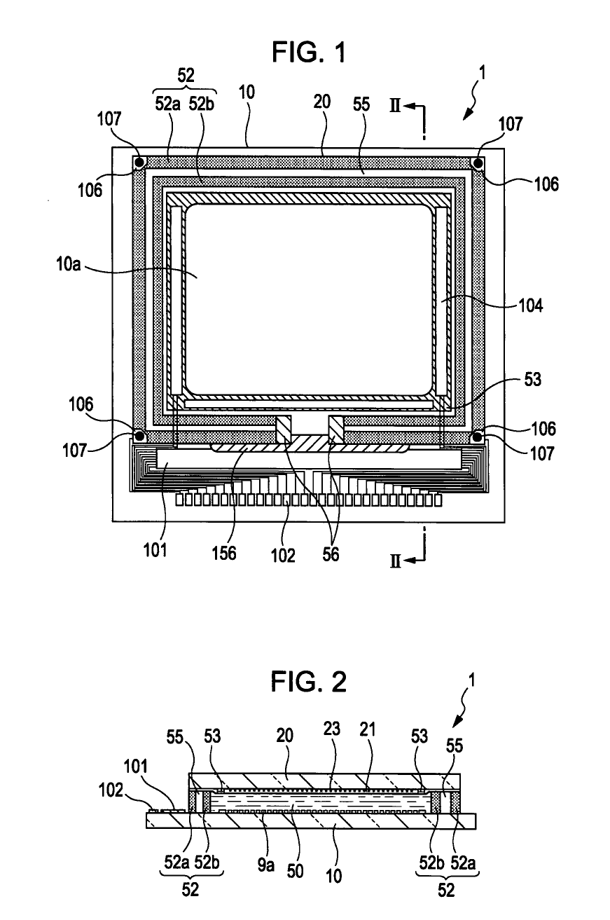

A liquid crystal display device according to a first embodiment of the invention will now be described with reference to FIGS. 1 and 2.

FIG. 1 is a plan view of a TFT active matrix liquid crystal display device 1 having built-in driving circuits. The liquid crystal display device 1 according to the first embodiment of the invention includes a TFT array substrate 10, in which components are arranged, and an opposite substrate 20. FIG. 2 is a cross-sectional view taken from line H-H′ of FIG. 1.

Referring to FIGS. 1 and 2, the liquid crystal display device 1 includes the TFT array substrate 10, the opposite substrate 20, a liquid crystal layer 50, a seal assembly 52, sealing portions 56, and a liquid crystal stopper 156.

In the liquid crystal display device 1, the TFT array substrate 10 is opposed to the opposite substrate 20.

The gap between the TFT array substrate 10 and the opposite substrate 20 is filled with liquid crystal, which constitutes the liquid crystal layer 50. The TFT array substrate 10 is joined to the opposite substrate 20 by the seal assembly 52 arranged in a sealing area located around an image display area 10a, in which a plurality of pixels are arranged.

The seal assembly 52 includes a first seal 52a and a second seal 52b. The first and second seals 52a and 52b are arranged in the sealing area surrounding the image display area 10a such that the seals 52a and 52b extend along the sealing area. More specifically, the first and second seals 52a and 52b extend along each of sides, which define the planar shape of the TFT array substrate 10, so as to surround the image display area 10a.

The first seal 52a is positioned outside the second seal 52b in the direction from the center of the image display area 10a to the periphery thereof. The first seal 52a is separated from the second seal 52b by a space 55.

Both ends of each of the first and second seals 52a and 52b are arranged in the vicinity of a liquid crystal inlet, through which liquid crystal is supplied to the gap between the two substrates to provide the image display area during manufacture of the liquid crystal display device 1. Each sealing portion 56 connects the respective ends of the first and second seals 52a such that the first seal 52a is coupled to the second seal 52b, thus sealing the space 55. A construction composed of the first and second seals 52a and 52b and the sealing portions 56 has a closed planar shape which surrounds the space 55. The liquid crystal stopper 156 is arranged between the sealing portions 56 which face each other with the liquid crystal inlet therebetween and seals the liquid crystal layer 50.

The seal assembly 52 is composed of, for example, a resin curable by ultraviolet rays or a thermosetting resin to join the two substrates. During manufacture of the liquid crystal display device 1, the resin is applied onto a surface of the TFT array substrate 10, the surface being to be opposed to the opposite substrate 20. After the two substrates are joined to each other, the substrates are irradiated with ultraviolet rays or are heated, thus curing the resin.

Referring to FIG. 4, the seal assembly 52 includes spacers 57, such as glass fibers or glass beads. The spacers are scattered so that the distance (gap) between the TFT array substrate 10 and the opposite substrate 20 is set to a predetermined distance. Since the first and second seals 52a and 52b extend around the image display area 10a, the spacers 57 included in the first and second seals 52a and 52b provide the uniform gap between the TFT array substrate 10 and the opposite substrate 20 in end portions of the respective substrates. Therefore, the gap between the TFT array substrate 10 and the opposite substrate 20 in the image display area 10a is uniform. Consequently, a reduction in image quality caused by the non-uniform gap between the two substrates can be prevented.

Again referring to FIGS. 1 and 2, the space 55 is enclosed by the first and second seals 52a and 52b and the sealing portions 56 on the surface of the TFT array substrate 10, the surface being to face the opposite substrate 20. In the following description, the surface will be termed the “inner surface”. When the TFT array substrate 10 is joined to the opposite substrate 20 with the sealing portions 56 and the first and second seals 52a and 52b therebetween, the space 55 is hermetically isolated from the outside of the liquid crystal display device 1.

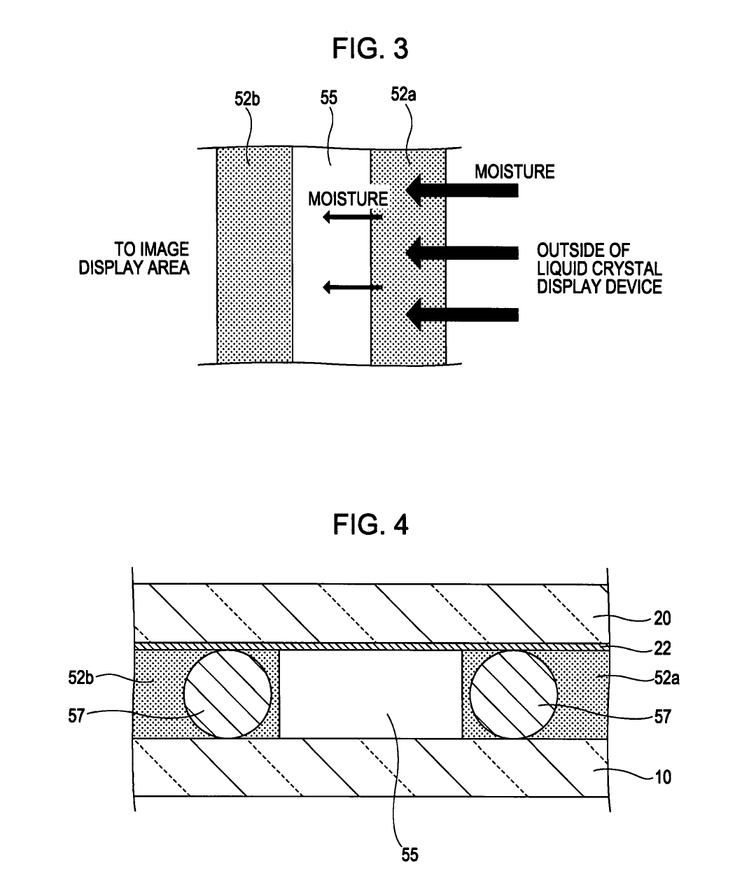

A reduction in the amount of foreign matter, such as moisture, penetrating the liquid crystal display device 1 will now be described in detail with reference to FIG. 3. FIG. 3 is a conceptual diagram explaining a reduction in the amount of penetrating foreign matter, e.g., moisture.

Referring to FIG. 3, the first and second seals 52a and 52b and the space 55 are arranged in the direction from the center of the image display area 10a to the periphery thereof. Advantageously, this arrangement can reduce the amount of foreign matter, such as moisture, penetrating into the image display area 10a from outside as compared with a case where the image display area 10a is surrounded by a single seal. More specifically, the space 55 between the first and second seals 52a and 52b functions as a buffer area against moisture and reduces the amount of foreign matter, such as moisture, which passes through the first seal 52a, serving as an outer seal, and reaches the second seal 52b, serving as an inner seal. Consequently, the amount of foreign matter, e.g., moisture, penetrating the image display area 10a can be remarkably reduced.

Again referring to FIGS. 1 and 2, the space 55 is three-dimensionally enclosed by the first and second seals 52a and 52b, the sealing portions 56, the TFT array substrate 10, and the opposite substrate 20 and is isolated from the outside. This arrangement, therefore, reduces the penetration of moisture from the ends of the first and second seals 52a and 52b into the space 55.

In this embodiment, the seal assembly 52 includes the first and second seals 52a and 52b. The seal assembly 52 may be composed of two or more seals. If the seal assembly 52 includes more seals, the amount of moisture penetrating the image display area 10a can be more effectively reduced. Specifically, when the seal assembly 52 includes three or more seals, the number of spaces, each of which is arranged between the adjacent seals, is increased in the direction from the center of the image display area 10a to the periphery thereof. Thus, the total space functioning as a buffer area against moisture is increased. Therefore, this arrangement can increase the sealing performance against moisture and reduce the width of each seal disposed in the direction from the center of the image display area 10a to the periphery thereof as compared with the case where the image display area 10a is surrounded by a single seal. Consequently, the width of the sealing area in which the plurality of seals are arranged can be reduced and a wider area on the inner surface, having a limited area, of the TFT array substrate 10 can be used as the image display area.

As described above, in the liquid crystal display device 1 in accordance with the present embodiment, the deterioration of the liquid crystal layer caused by the penetration of moisture can be suppressed, thus preventing a reduction in display quality. The good display quality of the liquid crystal display device 1 can be maintained for a long term.

Again referring to FIG. 1, a light shielding frame 53, composed of a light shielding film, is arranged on the opposite substrate 20 such that each side of the frame 53 is parallel to the corresponding inner side of the sealing area in which the seal assembly 52 is arranged. The light shielding frame 53 defines a frame portion of the image display area 10a. Part or the whole of the light shielding frame 53 may be embedded in the TFT array substrate 10. A peripheral area exists around the image display area 10a. In other words, a portion located outside the light shielding frame 53 remote from the center of the TFT array substrate 10 is defined as the peripheral area.

In a portion located outside the sealing area, in which the seal assembly 52 is arranged, in the peripheral area, a data line driving circuit 101 and external circuit connecting terminals 102 are arranged along one side of the TFT array substrate 10. A scan line driving circuit 104 is arranged along each of the sides adjacent to the above-described one side and is covered with the light shielding frame 53. A plurality of lines for connecting the two scan line driving circuits 104 arranged on both the sides of the image display area 10a are arranged along the remaining one side of the TFT array substrate 10 such that the lines are covered with the light shielding frame 53.

An inter-substrate conducting member 106 for conduction between the two substrates is arranged in each of four corners of the opposite substrate 20. In the TFT array substrate 10, an inter-substrate conducting terminal 107 is arranged in an area that faces each corner of the opposite substrate 20 where the inter-substrate conducting member 106 is arranged. Accordingly, electrical conduction between the TFT array substrate 10 and the opposite substrate 20 can be provided.

Referring to FIG. 2, an alignment layer is arranged on pixel electrodes 9a in the TFT array substrate 10 on which pixel switching TFTs and a plurality of lines, such as scan lines and data lines, are arranged. On the other hand, a common electrode 21 is arranged on the opposite substrate 20, a lattice or stripe light shielding film 23 is arranged on the common electrode 21, and an alignment layer 22 is disposed as an uppermost layer on the light shielding film 23 and the common electrode 21. The liquid crystal layer 50 is composed of, for example, one or several kinds of nematic liquid crystal and has a predetermined orientation state between the above-described two alignment layers.

The TFT array substrate 10 is a transparent substrate made of quartz, glass, or silicon. The opposite substrate 20 is a transparent substrate similar to the TFT array substrate 10.

The pixel electrodes 9a are arranged on the TFT array substrate 10 and the alignment layer subjected to a predetermined aligning process, such as rubbing, is arranged on the pixel electrodes 9a. Each pixel electrode 9a is composed of a transparent conductive film, such as an indium tin oxide (ITO) film. The alignment layer is composed of an organic film, e.g., a polyimide film.

The common electrode 21 is arranged on the whole of the inner surface of the opposite substrate 20, the inner surface facing the TFT array substrate 10. The alignment layer 22 subjected to a predetermined aligning process, e.g., rubbing, is disposed on the common electrode 21. The common electrode 21 is composed of a transparent conductive film, such as an ITO film. The alignment layer 22 is composed of an organic film, such as a polyimide film.

The liquid crystal layer 50 is disposed between the TFT array substrate 10 and the opposite substrate 20 arranged such that the pixel electrodes 9a are opposed to the common electrode 21. While an electric field is not applied from the pixel electrodes 9a, the orientation of the liquid crystal layer 50 is in the predetermined state by the alignment layers.

In addition to the driving circuits, such as the data line driving circuit 101 and the scan line driving circuit 104, a sampling circuit, a precharge circuit, and an inspection circuit may be arranged in the TFT array substrate 10 shown in FIGS. 1 and 2. The sampling circuit samples image signals in image signal lines to supply the signals to the data lines. The precharge circuit supplies a precharge signal having a predetermined voltage level to each data line before supply of the image signal. The inspection circuit inspects the liquid crystal display device during manufacture or before shipment to determine the quality of the device or find a defect.

As described above, the amount of moisture penetrating the image display area 10a is reduced in the liquid crystal display device in accordance with the present embodiment. If the liquid crystal display device is used in hot and humid conditions, high quality images can be displayed for a long term. In normal conditions, therefore, the liquid crystal display device can display images for a long term while a degradation in image quality is more effectively suppressed.

### 1-2: Modification of First Embodiment

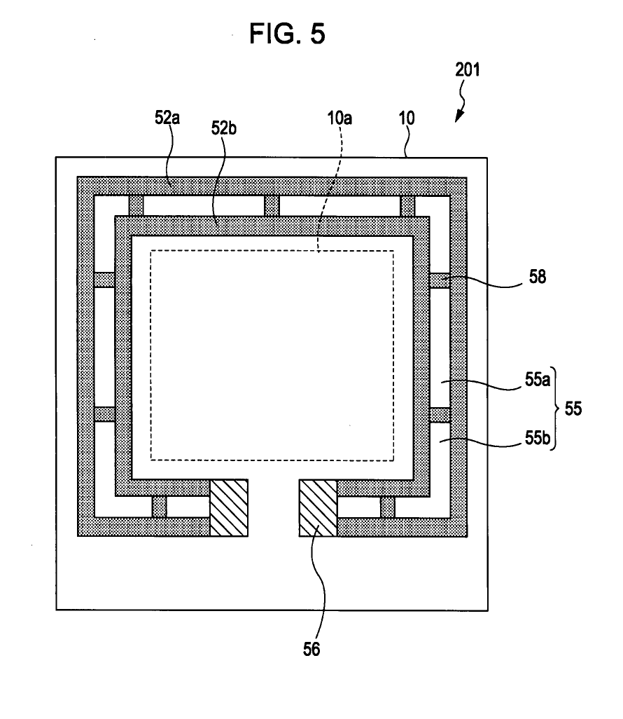

Referring to FIG. 5, a liquid crystal display device 201 includes partition walls 58, which are arranged in the space 55 to divide the space 55 into a plurality of segments 55a and 55b and other segments. The partition walls 58 and the seal assembly 52 are arranged in tandem or in parallel with one another. In the use of the partition walls 58, even when the hermeticity of any one of the segments 55a and 55b is degraded, foreign matter, such as moisture, penetrates from the relevant segment into the image display area 10a. Accordingly, the amount of moisture penetrating into the image display area 10a from the periphery thereof can be reduced.

### 1-3: Method of Making Liquid Crystal Display Device

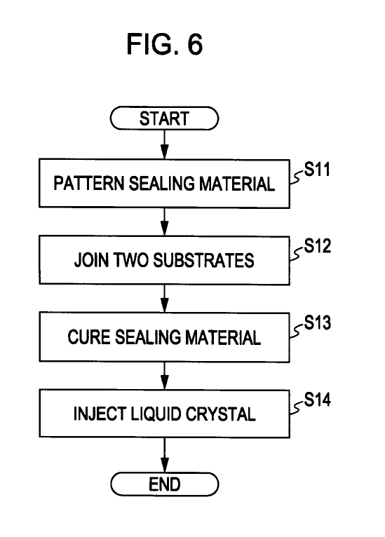

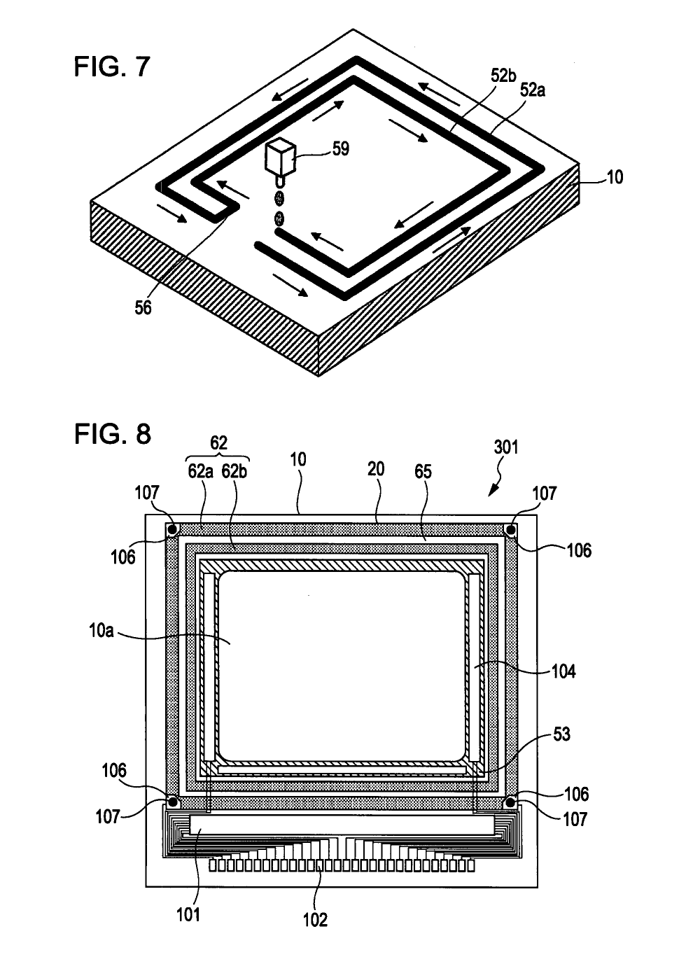

A method of making the liquid crystal display device according to the first embodiment will now be described with reference to FIGS. 6 and 7. FIG. 6 is a flowchart of the method of making the liquid crystal display. FIG. 7 is a perspective view explaining a step of forming the seal assembly in the method. According to the method, the above-described liquid crystal display device 1 can be made.

Referring to FIG. 6, in step S11, a sealing material is patterned on the inner surface of the TFT array substrate 10 on which a laminate including the data lines, the scan lines, and the TFTs, the pixel electrodes, and the alignment layer have been formed due to film formation by evaporation or sputtering, patterning by etching or photolithography, and heat treatment.

Referring to FIG. 7, the sealing material is applied to the sealing area by means of a supply unit, e.g., a dispenser 59 and is patterned as a single continuous line such that the sealing material corresponding to the first and second seals 52a and 52b and the sealing portions 56 extends along arrows in FIG. 7. Therefore, when the sealing material is continuously applied to the sealing area by the supply unit, e.g., the dispenser 59, such that a predetermined pattern of the material is formed, the seal assembly 52 and the sealing portions 56, which are uncured, can be easily patterned. In the method, the seal assembly 52 and the sealing portions 56 can be formed using the same material.

Again referring to FIG. 6, in step S12, the TFT array substrate 10 is joined to the opposite substrate 20 with the uncured seal assembly 52 and sealing portion 56 therebetween. In step S13, the seal assembly 52 and the sealing portions 56 are cured by irradiation with ultraviolet rays or heating, so that the seal assembly 52 and the sealing portions 56 fix the TFT array substrate 10 and the opposite substrate 20. In step S14, liquid crystal is injected into the gap between the TFT array substrate 10 and the opposite substrate 20, serving as the image display area 10a, through the inlet, thus forming the liquid crystal layer 50. After that, the liquid crystal layer 50 is sealed by the liquid crystal stopper 156, so that the liquid crystal display device is made.

As described above, according to this method, the liquid crystal display device in which a degradation in image display quality is relatively small after long use can be formed.

### Second Embodiment

### 2-1: Structure of Liquid Crystal Display Device

A liquid crystal display device according to a second embodiment of the invention will now be described with reference to FIG. 8. FIG. 8 is a plan view of essential components of a liquid crystal display device 301 according to the present embodiment.

Referring to FIG. 8, the liquid crystal display device 301 includes a seal assembly 62 composed of a first seal 62a and a second seal 62b.

The first and second seals 62a and 62b are arranged in a sealing area located around an image display area 10a. The liquid crystal display device 301 according to the second embodiment differs from the liquid crystal display device 1 according to the first embodiment in that both ends of each of the first and second seals 62a and 62b are connected to provide a hermetic space 65 between the first and second seals 62a and 62b. Specifically, each of the first and second seals 62a and 62b has a closed planar shape so as to surround the image display area 10a on the inner surface of a TFT array substrate 10. The seal assembly 62 can prevent a deterioration of a liquid crystal layer caused by penetration of moisture in a manner similar to the seal assembly in the liquid crystal display device 1 according to the first embodiment, thus preventing a degradation in display performance.

The seal assembly 62 may include three or more seals as in the case of the seal assembly 52 in the first embodiment. Furthermore, at least one partition wall may be arranged so as to divide the space between the adjacent seals into a plurality of segments. The same advantages as those of the liquid crystal display device 1 according to the first embodiment can be obtained.

The space 65 may be maintained under vacuum or be filled with an inert gas, such as nitrogen gas. When both of a step of applying liquid crystal onto the TFT array substrate 10 and a step of joining the TFT array substrate 10 to an opposite substrate 20, alternatively, only the step of joining the two substrates is performed in a vacuum or an atmosphere of an inert gas, such as nitrogen gas, as will be described below, the space 65 can be maintained under vacuum or be filled with the inert gas.

In the liquid crystal display device 301 in accordance with the present embodiment, the space 65 functions as a buffer area for reducing the amount of penetrating moisture as in the case of the liquid crystal display device 1 in accordance with the first embodiment. Advantageously, the amount of moisture penetrating into the image display area 10a from the outside of the device can be effectively reduced. In accordance with the present embodiment, therefore, the highly reliable liquid crystal display device capable of maintaining high display quality for a long term can be provided.

### 2-2: Method of Making Liquid Crystal Display Device

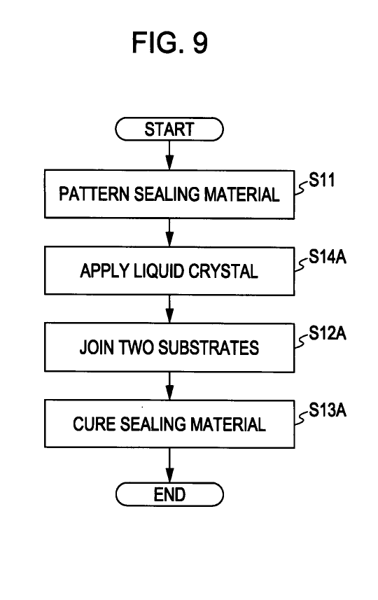

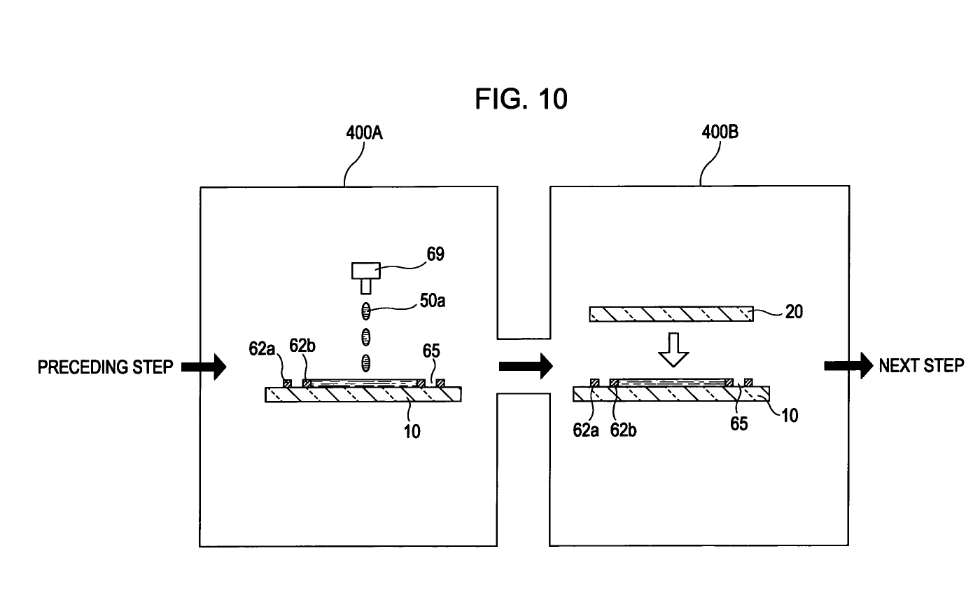

A method of making the liquid crystal display device according to the second embodiment will now be described with reference to FIGS. 9 and 10. FIG. 9 is a flowchart of the method of making the liquid crystal display device according to the second embodiment. FIG. 9 explains sequentially performed essential steps of the method. FIG. 10 is a diagram illustrating a step of applying liquid crystal and a step of joining the two substrates. According to this method, the above-described liquid crystal display device 301 can be produced. The method of making the liquid crystal display device according to the second embodiment is suitable for the one drop fill (ODF) process that is one of methods of making a liquid crystal display device.

Referring to FIG. 9, in step S11, the first and second seals 62a and 62b, which are uncured, are patterned on the inner surface of the TFT array substrate 10 on which a laminate including data lines, scan lines, and TFTs, pixel electrodes, and an alignment layer have been formed due to film formation by evaporation or sputtering, patterning by etching or photolithography, and heat treatment.

In step S14A, liquid crystal 50a is applied to an area, serving as the image display area 10a surrounded by the second seal 62b, by means of a supply unit, such as a dispenser 69. In step S12A, the TFT array substrate 10 is joined to the opposite substrate 20.

The step of applying liquid crystal and the step of joining the two substrates will now be described in detail with reference to FIG. 10.

Referring to FIG. 10, the TFT array substrate 10 on which the first and second seals 62a and 62b are arranged is transferred to a chamber 400A, which is evacuated or filled with an inert gas, such as nitrogen gas, and is overlaid with the liquid crystal 50a and is then transferred to a chamber 400B, which is evacuated or filled with the inert gas. In the chamber 400B, the TFT array substrate 10 is joined to the opposite substrate 20. Since the step of applying liquid crystal and the step of joining the two substrates are performed in the chambers, each of which is evacuated or filled with the inert gas, the space 65 separating the first and second seals 62a and 62b can be maintained under vacuum or be filled with the inert gas. In the liquid crystal display device completely constructed, the amount of moisture penetrating the image display area 10a can be remarkably reduced.

Again referring to FIG. 9, in step S13A, the uncured seal assembly 62 is cured by irradiation with ultraviolet rays or heating, thus fixing the TFT array substrate 10 to the opposite substrate 20 to form the liquid crystal display device including a liquid crystal layer between the TFT array substrate 10 and the opposite substrate 20.

As described above, the liquid crystal display device in which a deterioration in display quality is relatively small when the device is used for a long term can be realized in accordance with the second embodiment.

### Electronic Apparatus

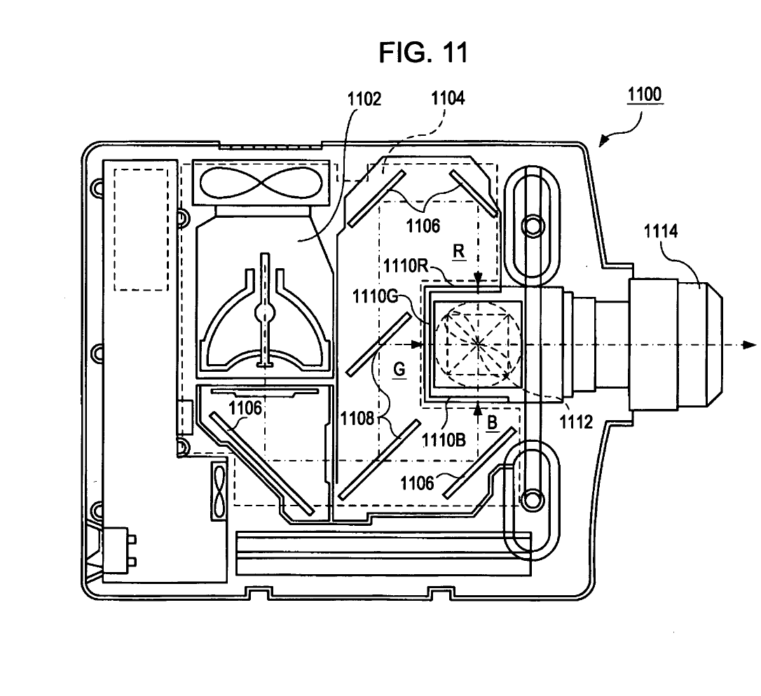

The above-described liquid crystal display devices according to the embodiments can be applied to various electronic apparatuses. As an example of an electronic apparatus including the liquid crystal display device according to any of the foregoing embodiments, a projector including light valves, each serving as the above-described liquid crystal display device, will now be described. FIG. 11 is a plan view of the structure of the projector. Referring to FIG. 11, a projector 1100 includes a lamp unit 1102, which is composed of a white light source, such as a halogen lamp. Light emitted from the lamp unit 1102 is split into three primary color light components of red (R), green (G), and blue (B), by four mirrors 1106 and two dichroic mirrors 1108 arranged in a light guide 1104. The three color light components R, G, and B are incident on liquid crystal display panels 1110R, 1110G, and 1110B, respectively. Each liquid crystal display panel serves as a light valve.

The structure of each of the liquid crystal display panels 1110R, 1110G, and 1110B is the same as that of the liquid crystal display device according to any of the foregoing embodiments. The liquid crystal display panels 1110R, 1110G, and 1110B are driven in accordance with R, G, and B primary color signals supplied from an image signal processing circuit. Light components, modulated by the liquid crystal display panels, coming from three directions are incident on a dichroic prism 1112. In the dichroic prism 1112, each of the light components R and B is refracted at 90 degrees and the light component G travels in a straight line. After images based on the respective light components are combined into a color image, the image is projected to a screen through a projection lens 1114.

Regarding images displayed on the respective liquid crystal display panels 1110R, 1110G, and 1110B, the image displayed on the liquid crystal display panel 1110G is a mirror-reversed image of the images displayed on the liquid crystal display panels 1100R and 1110B. Since the R, G, and B color light components are incident on the liquid crystal display panels 1110R, 1110G, and 1110B, respectively, by the dichroic mirrors 1108, it is unnecessary to arrange color filters.

Since the above-described electronic apparatus includes the liquid crystal display device according to any of the foregoing embodiments, a high quality image can be displayed. Consequently, highly reliable various electronic apparatuses, e.g., a projector display apparatus, a mobile phone, an electronic organizer, a word processor, view-finder type and monitor-direct-view type video tape recorders, a workstation, a videophone, a POS terminal, and a touch panel can be realized.

What is claimed is:

1. A liquid crystal display device comprising:
a first substrate;
a second substrate opposed to the first substrate;
a liquid crystal layer between the first and second substrates;
a first and second seals joining the first substrate to the second substrate, the first and second seals extending along edges of the first and second substrates, the first and second seal being disposed separated from each other with a space therebetween in the direction from the center of the display area to the periphery thereof; and
two sealing portions each connecting ends of the first and second seals to seal the space.

2. A liquid crystal display device comprising:
a first substrate;
a second substrate opposed to the first substrate;
a liquid crystal layer between the first and second substrates; and
a first and second seals joining the first substrate to the second substrate and extending along edges of the first and second substrates, the first and second seals being disposed separated from each other with a space therebetween in the direction from the center of the first and second substrates to the periphery thereof, both ends of first and second seals being connected such that the first and second seals surround a display area in which an image is displayed through the liquid crystal layer.

3. The device according to claim 1, wherein the space is maintained under vacuum or is filled with an inert gas.

4. The device according to claim 1, wherein each of the first and second seals includes spacers for maintaining the gap between the first and second substrates at a predetermined distance.

5. The device according to claim 1, further comprising at least one partition wall for dividing the space into a plurality of segments.
